(19) United States
(12) Patent Application Publication
(10) Pub. No.: US 2004/0201747 A1
(43) Pub. Date: Oct. 14, 2004

(54) Slow video mode for use in a digital still camera

(76) Inventor: Scott A. Woods, Bellvue, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/850,767

(22) Filed: May 8, 2001

(51) Int. Cl. H04N 5/225

(52) U.S. Cl. 348/231.99

(57) ABSTRACT

Image data is captured by a digital still camera at a rate characterized as slow video. The slow video data stream is slow enough that relatively slow memory can be utilized for on-the-fly storage of the slow video data stream. Audio data is recorded at the same time that image data is recorded at a slow video data rate, thereby accompanying the images collected in slow video mode. Synchronization markers are stored with the audio data, where each synchronization marker is associated with a single frame of the stored video data. As the audio data is played back, an individual video frame is retrieved and displayed when the corresponding synchronization marker is encountered.

### FIELD OF THE INVENTION

This invention relates to photography, and more particularly to the capture of moving image data at a slow rate in conjunction with the capture of audio data.

### BACKGROUND

Digital still cameras are ofen used to capture a number of individual still images and store them in a memory device, such as flash memory, a hard disk drive, a floppy disk, or a proprietary memory format. Digital still cameras also, or instead, typically include internal memory, such as SDRAM. Internal memory may be used to buffer incoming image data before writing it to the memory device, or to store image data over a long period of time.

Some digital still cameras include the capability to record short video clips as well. Video clips are typically captured in NTSC format or a similar format, such as PAL, requiring the capture of large amounts of image data at a high rate.

Traditionally, video frames are captured at 30 frames per second. Given a standard YCC 4:2:2 format driving a quarter VGA video signal, each frame may consist of 320×240×2 bytes of data, or almost 153,600 bytes, yielding megabytes of data that must be processed and stored every second. Such amounts of data can rapidly overwhelm the capacity of the internal memory. As a result, the length of video clip that can be captured by a digital still camera has been limited to a few tens of seconds, at most, by the storage capacity of the internal memory. Further, due to the high rate of the video data stream, relatively fast memory such as synchronous dynamic random access memory (SDRAM) must be used to receive the video data at that rate. Such relatively fast memory is costly, and adding memory capacity is consequently expensive, if the space limitations within the body of the camera even allow room for the addition of memory.

### SUMMARY

A slow video mode is provided for a digital still camera, allowing it to capture moving image data at a decreased rate compared to standard video. The digital still camera allows for the capture and playback of audio data in synchronization with the slow video image data.

In one aspect of the invention, image data is captured by the digital still camera as successive single video frames, at a rate characterized as slow video. By providing a slow video capture rate, memory capacity within the camera is conserved. Further, the slow video data stream is slow enough that relatively slow memory can be utilized for on-the-fly storage of the slow video data stream.

In another aspect of the invention, audio data is recorded at the same time that image data is recorded at a slow video data rate, thereby accompanying the images captured in slow video mode. Synchronization markers are stored with the audio data, where each synchronization marker is uniquely associated with a single frame of the stored video data. The combination of audio and slow video data is useful in applications where video data capture is less important than audio capture.

In another aspect of the invention, the slow video image data and the audio data are synchronized for playback. As the audio data is played back, an individual video frame is retrieved and displayed when the corresponding synchronization marker is encountered. In this way, the slow video images properly correspond to the audio data as both are played back to a user.

The invention will be more fully understood upon consideration of the detailed description below, taken together with the accompanying drawings.

### BRIEF DESCRIPTION OF THE DRAWINGS

FIG. 1 is a block diagram of a digital still camera.

FIG. 2 is a flow chart of a method for capturing image data in slow video mode.

FIG. 3 is a block diagram of an audio data file.

FIG. 4 is a flow chart of a method for playing back audio and video data captured in slow video mode.

Use of the same reference symbols in different figures indicates similar or identical items.

### DETAILED DESCRIPTION OF THE PREFERRED EMBODIMENTS

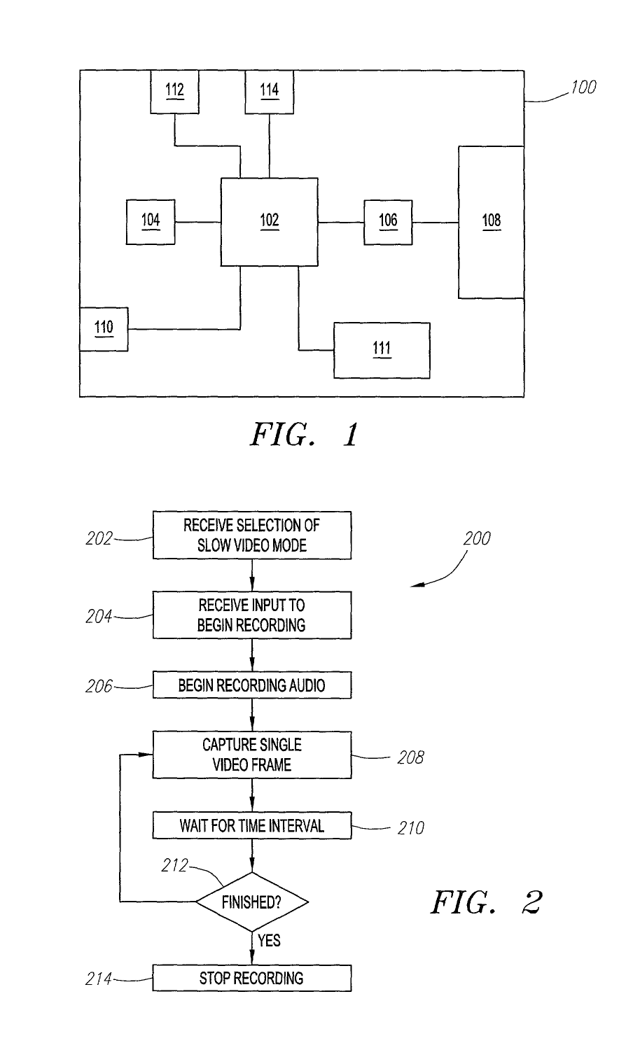

Referring to FIG. 1, a digital still camera 100 is shown. The digital still camera 100 includes a controller 102 for controlling the operation of the camera 100. The controller 102 may be an application-specific integrated circuit (ASIC), a microprocessor, a digital signal processor (DSP), or any other information handling device. An image acquisition device 104 is electrically connected to the controller 102. The image acquisition device 104 is used to convert light into electrical signals. The image acquisition device 104 may be a charge-coupled device (CCD), a complementary metal-oxide-silicon (CMOS) device, or any other suitable device. In one embodiment, the controller 102, or circuitry electrically connected to it, also performs any necessary analog to digital (“A/D”) conversion of the signal received from the image acquisition device 104. In another embodiment, the controller 102 is electrically connected to a separate A/D converter for converting the signal from the image acquisition device 104 into digital form

In one embodiment, the controller 102 is electrically connected to internal memory 106 within the camera 100. In one embodiment, the internal memory 106 is fixed within the camera 100. In one embodiment, the internal memory 106 is fast memory, such as SDRAM. A memory storage unit 108 may be electrically connected to the internal memory 106, as shown. In another embodiment, the memory storage unit 108 may be electrically connected to the controller 102. The memory storage unit 108 may be a single device, or the combination of a removable storage medium and a receiver, in which case the term “memory storage unit 108” refers to the removable storage medium as received into the camera 100. The memory storage unit 108 may be any data storage device, such as flash memory, a hard disk drive, a floppy disk, or a proprietary memory format device. In another embodiment, the internal memory 106 and/or the memory storage unit 108 may be directly connected to the image acquisition device 104, such that data flows directly from the image acquisition device 104 to the internal memory 106 and/or the memory storage unit 108 before being retrieved for processing by the controller 102. Both the relatively fast internal memory 106 and the relatively slow memory storage unit 108 each have a maximum data acceptance rate.

In one embodiment, the camera 100 includes a microphone 110 electrically connected to the controller 102. The microphone 110 is standard, and may be a unidirectional microphone, an omnidirectional microphone, or other type of microphone 110. In another embodiment, the microphone 110 is a remote microphone, separate from the camera 100 and connected to the camera 100 by a cable. In another embodiment, the microphone is a wireless remote microphone, adapted to transmit audio signals over a wireless band to a receiver (not shown) in the camera 100, which in turn is connected to the controller 102. The controller 102, or circuitry electrically connected to it, also performs any necessary A/D conversion of the signal received from the microphone 110. In another embodiment, the controller 102 is electrically connected to a separate A/D converter for converting the signal from the microphone 110 into digital form.

In one embodiment, the camera 100 includes a display 111 electrically connected to the controller 102. The display 111 may be electrically connected directly to the internal memory 106 or the memory storage unit 108. The display 111 may be a liquid crystal display or other type of display.

In one embodiment, the camera includes a slow video control 112 and a recording control 114. The slow video control 112 may be a separate control on the camera 100, such as a switch. The function of the slow video control 112 is described later in this document. In another embodiment, the slow video control 112 is incorporated into the control interface of the camera 100. For example, the slow video control may be toggled via a graphic user interface on the display 111. In this example, a cursor is navigated through a list of choices on the display 111 via a cursor control (not shown) on the camera 100. Similarly, the recording control 114 may be a separate control on the camera 100, such as a switch. The function of the recording control 114 is described later in this document. In another embodiment, the recording control 114 is incorporated into the control interface of the camera 100. For example, the recording control may be toggled via a graphic user interface on the display 111. In another embodiment, the recording control 114 is not provided, such that the slow video control 112 controls the functionality that would otherwise be controlled by the recording control 114.

Referring as well to FIG. 2, a method 200 for capturing image data in slow video mode is shown. In block 202, the camera 100 receives the selection of slow video mode from a user. Preferably, the selection is received by the controller 102 within the camera 100. The user may select slow video mode in a number of ways. In one embodiment, the user presses or otherwise activates the slow video control 112 described above to select slow video mode. In another embodiment, the slow video control 112 is incorporated into the control interface of the camera 100 as described above, and the user selects the slow video mode via, for example, a graphic user interface on the display 111. Slow video mode operates at a speed substantially less than the thirty frames per second of standard NTSC video. Advantageously, slow video mode operates at a speed of one frame per second, or less. However, other speeds may be used. The slow video speed may be measured by the number of video frames captured per second or by the interval between those frames, or by other measurements. In one embodiment, a single slow video speed is provided by default. That is, the controller 102 is capable of controlling the acquisition of images in slow video mode at a single speed, such as one frame per second. In another embodiment, the user can select the speed of the slow video mode from a number of available speeds. This selection may be made via the slow video control 112 or another control on the camera 100. Thus, in block 202, a speed for the slow video mode is determined, such that a particular time interval between successive single video frames is set.

In block 204, the camera 100 receives input from a user to begin recording in slow video mode. Preferably, the selection is received by the controller 102 within the camera 100. In one embodiment, the user presses or otherwise activates the recording control 114 described above to begin recording video images. In another embodiment, the recording control 114 is incorporated into the control interface of the camera 100 as described above, and the user begins recording via, for example, selecting the appropriate icon in a graphic user interface on the display 111. In another embodiment, blocks 202 and 204 are combined, such that the selection of the slow video control 112 automatically provides input to the controller 102 to begin recording in slow video mode. In such an embodiment, the separate recording control 114 need not be provided, simplifying the construction and use of the camera 100.

Next, in block 206, the camera 100 begins recording audio. In one embodiment, audio information is captured by the microphone 110, where it is converted into electrical signals and transmitted to the controller 102. As described above, the controller 102 may include an A/D converter, or may be connected to a separate A/D converter, which converts analog signals from the microphone 110 into digital data. The controller 102 formats the audio data into a particular format, such as .WAV or .MP3, and passes the digital audio data to the internal memory 106 and/or the memory storage device 108 as it is recorded. The method 200 then moves to block 208.

In block 208, the camera 100 captures a single video frame. In one embodiment, blocks 206 and 208 are performed substantially simultaneously. In another embodiment, block 208 may be performed before block 206. The capture of an image as a single video frame is standard to one of ordinary skill in the art. In one embodiment, the video frame is captured as an NTSC video frame in a standard YCC 4:2:2 format driving a quarter VGA video signal. Such a single video frame consists of 320×240×2 bytes of data, or almost 153,600 bytes. The video frame may be captured in another format, which may utilize more or fewer bytes for a single video frame. For example, the single video frame may be in PAL format or HDTV format. The particular format of the single video frame is not critical. The single video frame is captured in a standard manner wherein an image received on the image acquisition device 104 is converted to an electrical signal, transmitted to the controller 102, then transmitted to the internal memory 106 and/or a memory storage device 108. In another embodiment, the electrical signal generated at the image acquisition device 104 may be transmitted directly to the internal memory 106 and/or memory storage device 108. As described above, the controller 102 may include an A/D converter, or may be connected to a separate A/D converter, which converts analog signals from the image acquisition device 104 into digital data. The controller 102 may format the video data into a particular format, then pass the digital audio data to the internal memory 106 and/or the memory storage device 108 as it is recorded. In another embodiment, the video data representing the single video frame may take a different path through the camera 100. By capturing an image at video resolution as a single video frame, rather than capturing an image at photographic resolution, the size of the image is reduced, as is the amount of memory needed to store it.

In block 210, for a time interval as determined in block 202, video data is not recorded. The duration of the interval is a function of the speed of the slow video mode, as described above, such that the interval is the time between successive individual single video frames. Audio data continues to be recorded during the interval, even though no video data is captured during the interval. Put another way, the audio data stream is substantially continuous, while the video data stream is intermittent.

In block 212, the method 200 checks whether the recording is complete. In one embodiment, the controller 102 checks for a stop signal representing an input from the user, such as a second depression of the recording control 114, to indicate that the user wishes to cease recording. In one embodiment, if the user provides an input that recording is complete during the interval of block 210, the entire interval is allowed to run before block 212 is performed, at which time the user input is sensed and acted upon. In another embodiment, if the user provides an input that recording is complete during the interval of block 210, the interval is interrupted, and block 212 is performed. The interval of block 210 may be shortened by the receipt of a command from the recording control 114 to stop recording. If, after the interval, the user is not done recording, the method 200 moves back to block 208, in which another single video frame is captured. In this way, the interval of block 210 separates the capture of successive single video frames. In block 212, if the user is done recording, then the -process continues to block 214, in which the recording of audio and video data is terminated.

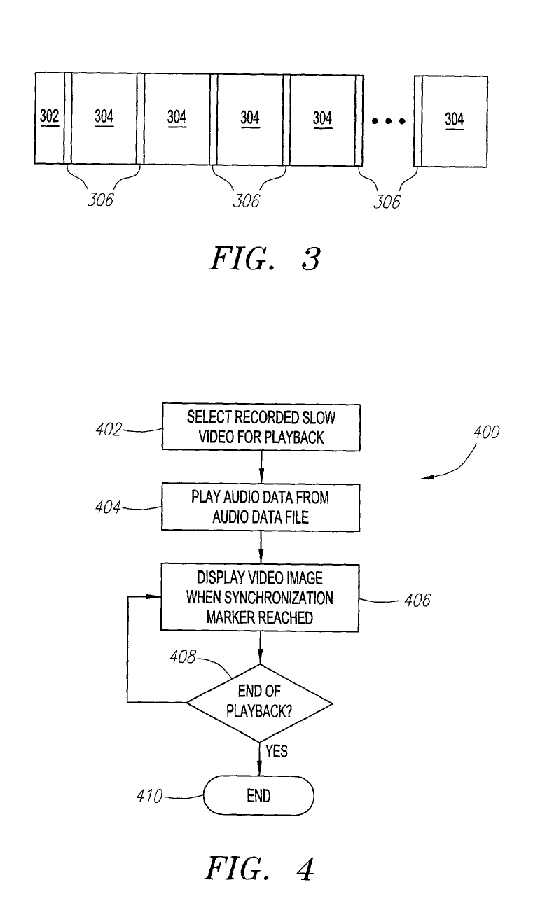

The captured successive video frames and audio data are stored, forming one or more data files. Referring as well to FIG. 3, a block diagram of a stored audio data file is shown. An audio data file 300 includes a header 302. The header 302 may contain a unique identifier for the audio data file 300, as well as other information. The audio data file 300 also includes audio data 304. Audio data 304 forms an audio data stream through the controller 102 and into the internal memory 106 or the memory storage unit 108, where that audio data 304 is written to the audio data file 300 as it is collected. In one embodiment, the audio data stream has a substantially constant rate. As an example, at four bits per sample, at 10-20,000 samples per second, the audio data stream has a rate between 5-10 Kbytes/sec. Thus, the audio data stream has a lower rate than the video stream, even at a video stream rate of one frame every 1-2 seconds. As an example, at a video stream rate of one frame every 2 seconds, the audio data stream has a rate between 5000-10,000 bytes per second, while the video stream rate is substantially 76,800 bytes per second.

In one embodiment, the audio data 304 is written on-the-fly directly to the relatively slow memory storage unit 108, where it is stored in the audio data file 300. In another embodiment, the audio data 304 is written to the relatively fast internal memory 106, where it is stored in the audio data file 300. In another embodiment, audio data 304 is buffered in the internal memory 106 before being written to the memory storage unit 108. In block 208, each time a single video frame is captured, a synchronization marker 306 is written to the audio data file 300. The synchronization marker 306 is used for playing back images and sound in slow video mode, as explained below. The synchronization marker 306 is preferably written to memory on-the-fly in the same manner as the audio data 304.

Similarly, video data forms a video data stream through the controller 102 and into the internal memory 106 or the memory storage unit 108. The video data stream is discontinuous, meaning that its rate is not constant. Rather, because individual video frames are taken at times separated by a fixed interval, transmission of individual video frames creates an intermittent video data stream. As stated above, in one embodiment each video frame contains substantially 153,600 bytes. The rate at which those bytes are transmitted from the image acquisition device 104 to the controller 102, then from the controller 102 to the internal memory 106, memory storage unit, or both, varies depending on the particular image acquisition device 104 and controller 102 used. In one embodiment, the image acquisition device 104 and controller 102, and the slow video mode speed or range of permissible speeds, are selected such that the bit rate of the video data stream is less than or equal to the maximum rate at which the memory storage unit 108 can accept data. In this way, the relatively slow memory storage unit 108 can be used to store video data directly.

The user may later play back the audio and video captured via the method 200. In one embodiment, the user plays back audio and video on the camera 100, viewing the video on the display 111 and listening to the audio through a speaker (not shown), headphones connected to a headphone jack (not shown), or other sound reproduction devices. In another embodiment, the memory storage unit 108 includes a removable storage device, such as a floppy disk, which is inserted into a separate information handling system (not shown) for playback, where the information handling system includes or is connected to a display. The particular hardware and software utilized to play back audio and video is not critical.

Referring to FIG. 4, a method 400 for playing back audio and video in slow video mode is shown. First, in block 402, a particular audio data file 300 and its associated video images are selected for playback. The selection of a particular data file by a user is standard. As described above, the audio data file 300 includes a header 302 having a unique identifier, allowing the particular audio data file 300 to be selected. This selection may take place in a number of ways. In one embodiment, playback is selected via a graphic user interface on the display 111 of the camera 100. In another embodiment, playback is performed on a separate information handling system utilizing a graphic user interface, and the user clicks on a data file to select it, or double-clicks on it to open it. The particular interface by which a user selects a particular audio data file 300 and its associated video images is not critical.

In block 404, the audio data 304 in the audio data file 300 is played. Playback of digital audio is standard in the art, and may be performed in software, hardware, firmware, or a combination thereof. In one embodiment, where playback is performed in the camera 100, the controller 102 is used to play back the audio data 304.

In block 406, the controller 102, software run on the controller 102, or other hardware or software playing the audio data 304, detects that a synchronization marker 306 has been reached. That is, each synchronization marker 306 is associated with a particular time in the playback of the audio data 304, and is encountered at that time. Each synchronization marker 306 is stored in the audio data file 300 such that it substantially does not interfere with the playback of the audio data 304. Each synchronization marker 306 is associated with a stored single video frame. In one embodiment, the synchronization marker 306 includes a unique identifier for a single video frame. In another embodiment, the synchronization marker 306 includes the memory address of a single video frame. The particular data structures, identifiers and methods used to associate a particular synchronization marker 306 with a particular single video frame are not critical. In one embodiment, the controller 102 and/or software running thereon then utilizes the unique identifier within the synchronization marker 306 to retrieve the associated single video frame from the location where it is stored. In one embodiment, where playback is performed in the camera 100, the single video frame may be retrieved from its storage location in the internal memory 106 or in the memory storage unit 108. The controller 102 and/or software running thereon then displays the retrieved single video frame on the display 111. In another embodiment, circuitry electrically connected to the controller 102, rather than the controller 102, performs block 406.

In another embodiment, the audio data block 300 and the associated video frames are stored in and played back on an information handling system separate from the camera 100. Playback in such an embodiment takes place substantially as described above with regard to playback within the camera 100.

In block 408, the process 400 determines whether the end of playback has been reached. The end of playback may be reached upon playback of an entire set of video images and their associated audio data file 300, upon receipt of user input to stop playback, or upon other events or inputs. If playback is complete, the process 400 ends in block 410.

If playback is not complete in block 408, the process 400 returns to block 406. The audio data 304 continues to be played, and the next synchronization marker 306 is reached. Upon reaching the next synchronization marker 306, the next stored single video frame is displayed. The transition between the display of successive single video frames may be handled in several different ways. In one embodiment, the next single video frame is simply displayed in place of the previous frame, with no transition effects. That is, the next single video frame is displayed abruptly. In another embodiment, a transition is provided between successive single video frames. Such a transition may occur for a fraction of the time that each single video frame is displayed, or may occur on an ongoing basis to provide an interesting visual effect. As one example, each new frame may fade into the preceding frame. As another example, each new frame may be alpha-blended into the preceding frame. As another example, each new frame may scroll into the preceding frame from any direction—left, right, top, bottom, diagonally, or otherwise. The meanings of “fade,” “alpha-blended” and “scroll” are standard in the art. Other types of visual transitions between successive frames may be used, if desired. In one embodiment, the user may select whether to use a transition between frames, and/or may select among the different types of transitions. In another embodiment of the process 400, a synchronization marker 306 precedes audio data 304 in the audio data file 300, in which case the single video frame associated with that synchronization marker 306 is retrieved and displayed before the playback of audio data 304 begins. In other respects, the method 400 proceeds as described above.

Slow video mode is useful for applications in which audio data is of primary importance, but where a certain amount of visual information is still desired. For example, slow video mode may be used at a lecture, to record the audio portion of the lecture in full, and to obtain some images of the lecturer. Because a lecturer is typically somewhat static, the visual portion of the lecture is generally less important to the attendee than the content of the lecturer's message. As another example, a user may wish to capture video of an event, but may have only limited memory remaining in the internal memory 106 or memory storage unit 108. By using the slow video mode, the user can still obtain some visual information, as desired, while continuously recording audio. As another example, the user can place the camera 100 on a tripod, facing scenery. The microphone 110 in this example is a wireless microphone, and the user clips it to his or her shirt. The user can then walk around the field of view of the camera and speak, capturing images of the scenery as well as his or her narration.

Although the invention has been described with reference to particular embodiments, the description is only an example of the invention's application and should not be taken as a limitation. Consequently, various adaptations and combinations of features of the embodiments disclosed are within the scope of the invention as defined by the following claims and their legal equivalents.

What is claimed is:

1. A method for capturing images, comprising:
providing a digital still camera having a memory;
capturing audio data substantially continuously, wherein said audio data forms an audio data stream;
capturing a video frame;
waiting for an interval; and
repeating said capturing said video frame and said waiting, wherein said captured video frames form a video data stream.

2. The method of claim 1, wherein the memory accepts data at up to a maximum rate, and wherein said video data stream has a bit rate no greater than said maximum rate.

3. The method of claim 2, wherein said audio data stream and said video data stream are recorded directly to the memory.

4. The method of claim 1, further comprising selecting a particular duration for said interval.

5. The method of claim 1, wherein said interval is substantially between one and two seconds.

6. The method of claim 1, further comprising inserting a synchronization marker into said audio data each time one of said video frames is captured.

7. The method of claim 6, wherein each synchronization marker corresponds to a particular captured video frame.

8. A method for replaying stored video frames and audio data, the audio data including at least one synchronization marker associated with a stored video frame, the method comprising:
playing back said audio data;
detecting a synchronization marker; and
displaying the particular stored video frame corresponding to said detected synchronization marker.

9. The method of claim 8, further comprising:
detecting a second synchronization marker; and
displaying the particular stored video frame corresponding to said second synchronization marker.

10. The method of claim 9, further comprising providing a transition between successive displayed video frames.

11. The method of claim 10, wherein said transition comprises fading.

12. The method of claim 10, wherein said transition comprises alpha-blending.

13. The method of claim 10, wherein said transition comprises scrolling.

14. The method of claim 9, wherein the particular stored video frame corresponding to said second synchronization marker is displayed abruptly.

15. The method of claim 8, further comprising receiving user input regarding the display of successive stored video frames.

16. A digital still camera, comprising:
an image acquisition device;
a controller electrically connected to said image acquisition device, wherein a video data stream passes through said controller at a maximum bit rate; and
first memory electrically connected to said controller, said first memory having a maximum data acceptance rate, wherein said maximum bit rate of said video data stream is no greater than said maximum data acceptance rate of said memory.

17. The camera of claim 16, wherein said first memory is flash memory.

18. The camera of claim 16, further comprising a second memory faster than said first memory.

19. The camera of claim 18, wherein said second memory is synchronous dynamic random-access memory.
